(19) United States
(12) Patent Application Publication
(10) Pub. No.: US 2012/0188406 A1
(43) Pub. Date: Jul. 26, 2012

(54) REDUCED POWER CONSUMPTION FILTER

(75) Inventor: Edward Craig Hyatt, Cupertino, CA (US)

(73) Assignee: Apple Inc., Cupertino, CA (US)

(21) Appl. No.: 13/010,685

(22) Filed: Jan. 20, 2011

(51) Int. Cl. H04N 5/225; G06K 9/68

(52) U.S. Cl. 348/231.99; 348/222.1; 382/218; 348/372; 348/E05.024

(57) ABSTRACT

There are provided systems and techniques for reducing power consumption in video image capture devices. In particular, in some embodiments, a computing system is provided that includes an image capture device and an application specific integrated circuit (ASIC) filter coupled to the image capture device. The ASIC filter includes an averaging circuit configured to provide an output representing an average value of a first set of values of a pixel grouping and an outlier determining circuit configured to determine if a value of a target pixel is outside a range of values for first set of values of the pixel grouping. A multiplexer is provided and configured to replace the value of the target pixel with the average value if the value of the target pixel is determined to be an outlier.

### BACKGROUND

1. Technical Field

The present application is directed to power consumption reduction and, more particularly, to reducing power consumption when processing images.

2. Background

In computing systems, such as smartphones, notebook computers, tablet computers, and the like, one of the more computationally expensive processes is the capture of moving images. In general, the power requirements for the recoding of high definition (HD) video has generally not scaled well with increasing resolution and frame rates relative to standard definition video recording. Typically, image processing includes filtering noise from the images. Noise may be classified as spatial or temporal. Temporal noise includes noise that varies over time and may include dark noise and photon noise. Noise filtering is implemented to provide increased image quality.

Current filtering techniques may generally be executed by a central processing unit (CPU), digital signal processor (DSP), or other processing unit which may contribute to the high power requirements of processing HD video images. For example, in some current designs a Temporal Noise Reduction (TNR) process may be executed by the central processing unit (CPU) or DSP to remove random noise. The TNR process, and other similar filtering processes, may include multiple read and write operations to memory for each pixel. The multiple reads and writes per pixel not only contribute to power consumption, but also present issues with respect to timing. That is, the speed at which the TNR process may run is constrained by the speed at which multiple read and write operations with the memory may be carried out. Moreover, the CPU consumes a significant amount of power as it operates at a high rate to fetch and process the image data in real-time (currently 30 frames per second (fps) or about 33 milliseconds per frame).

### SUMMARY

A noise filter is provided that may be implemented in hardware to reduce the consumption of power when processing video image data. In particular, in some embodiments, an application specific integrated circuit may be coupled to an image capture device and configured to filter image data prior to providing the image data to a processor for further processing and/or before writing the data to memory or storage.

In some embodiments, a computing system is provided that includes an image capture device and an application specific integrated circuit (ASIC) filter coupled to the image capture device. The ASIC filter includes an averaging circuit configured to provide an output representing an average value of a first set of values of a pixel grouping and an outlier determining circuit configured to determine if a value of a target pixel is outside a range of values for first set of values of the pixel grouping. A multiplexer is provided and configured to replace the value of the target pixel with the average value if the value of the target pixel is determined to be an outlier.

In other embodiments, a method of filtering noise from digital images may be implemented. The method may include reading a set of pixel values into a register pipeline, finding a minimum value of a first portion of the set of pixel values, and finding a maximum value of the first portion of the set of pixel values. A value of a target pixel may be compared with the minimum and maximum values to determine if the value of the target pixel is an outlier. Additionally, an average value of the first set of pixels may be determined and if the value of the target pixel is an outlier, it is replaced with the with the average value.

In still other embodiments, a power reduction system is provided that includes a processor and a charge-coupled device (CCD) for image capture coupled to the processor. A filter device is coupled to between the CCD and the processor. The filter device is configured to determine if a value of a target pixel is an outlier relative to a range of values representing a set of pixels surrounding the target pixel. If the target pixel is an outlier, the filter replaces the value of the target pixel with an average of the values of the pixels surrounding the target pixel and outputs the average of the range of values. If, however, the value of the target pixel is within the range of values representing the pixels surrounding the target pixel, the set of hardware outputs the value of the target pixel.

While multiple embodiments are disclosed, still other embodiments of the present invention will become apparent to those skilled in the art from the following Detailed Description. As will be realized, the embodiments are capable of modifications in various aspects, all without departing from the spirit and scope of the embodiments. Accordingly, the drawings and detailed description are to be regarded as illustrative in nature and not restrictive.

### BRIEF DESCRIPTION OF THE DRAWINGS

FIG. 1 illustrates a computing device.

FIG. 2 illustrates a backside of the computing device of FIG. 1.

FIG. 3 is a block diagram of the computing device of FIG. 1.

FIG. 4 is a flow diagram for an application specific integrated circuit of the computing device of FIG. 1.

FIG. 5 illustrates tiered logic implemented to determine a vector maximum.

FIG. 6 illustrates tiered logic implemented to determine a vector minimum.

FIG. 7 illustrates a register compare, comparing the vector maximum and the vector minimum determined by the tiered logic of FIGS. 5 and 6, respectively, with a target pixel value.

FIG. 8 illustrates a logical AND performed on the output of the register compares of FIG. 7.

FIG. 9 illustrates a multiplexer utilizing the output of the logical AND as a select (sel) signal and receiving inputs of an average value and the target value, to output a value for the target value.

FIG. 10 illustrates a vector summing machine configured to sum register values in a Log base two of N stages manner.

FIG. 11 illustrates a register shift to achieve a divide by eight.

FIG. 12 illustrates a register shift performed on an output of the vector summing machine of FIG. 10 and a vector shift on a hexadecimal value to achieve a divide by eight.

FIG. 13 illustrates a vector shift to achieve a divide by eight with simultaneous register shifts.

FIG. 14 is a flow chart illustrating a method of filtering noise.

### DETAILED DESCRIPTION

A real-time noise filter is provided that may be implemented in hardware to reduce the consumption of power when processing video image data. In particular, as camera data flows between the camera and processors of a computing system, a filtering device may be implemented to filter the data enroute with hardware. The hardware functions by implementing a simplified non-linear filter which does not require multiple frames and does not have a feedback loop. In some embodiments, the filter may examine eight pixels surrounding a target pixel and if the target pixel has a value that falls within the range of values for the eight pixels it is preserved. However, if the target pixel value is outside the range of values for the eight pixels it is replaced by an average value. In some embodiments, a smoothing algorithm may be strengthened by increasing the number of pixels considered by the filter.

Additionally, the hardware algorithm disclosed herein may operate on single planes of pixel data or may convert multiple planes to luminance data in real time hardware. That is, a color image may be converted to a luminance only image (e.g., a black and white image) using hardware and then the noise may be removed from the luminance channel by hardware. In the case of nine total pixels (eight pixels plus one), the pixel values would be converted to luminance values and the output would be the noise filtered luminance channel. In some embodiments, an application specific integrated circuit may be coupled to an image capture device and configured to filter image data prior to providing the filtered image data to a processor for further processing and/or before writing the data to memory or storage, thus reducing the computational expense of filtering the data and reducing the power consumption of the filtering process.

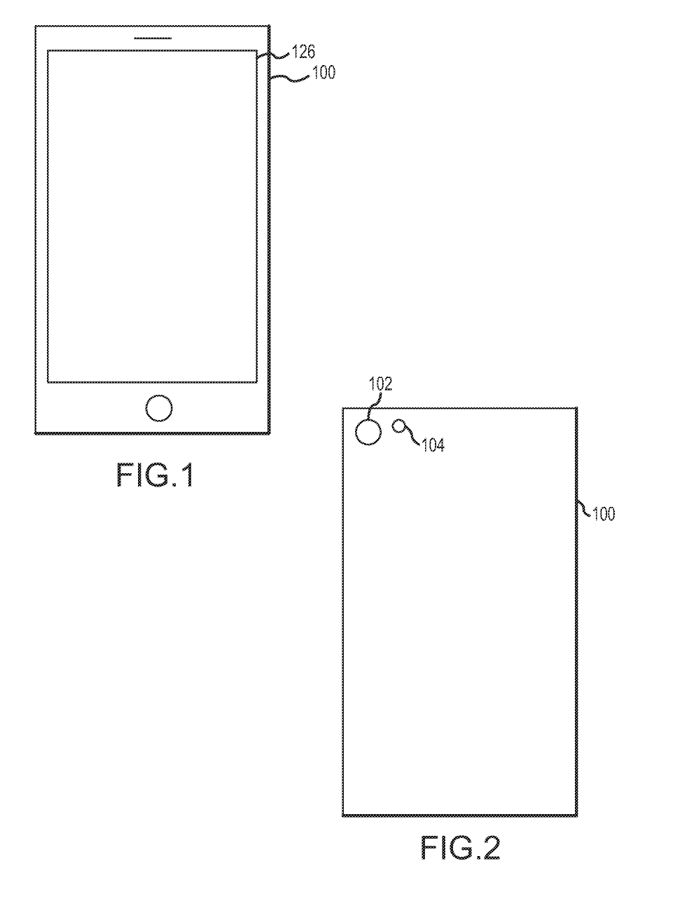

Turning to the drawings and referring initially to FIG. 1, a computing device 100 is illustrated having digital image capture capabilities in accordance with an example embodiment. In particular, the illustrated computing device 100 may be a smart phone. FIG. 2 shows a backside of the computing device 100 of FIG. 1 having a camera 102 and a flash 104. It should be appreciated that the hardware, software, techniques and/or methods described herein may be implemented in computing devices other than smart phones. Indeed, a notebook, tablet, or other computing device may be configured with digital image capture capabilities and, hence, may implement the techniques described herein.

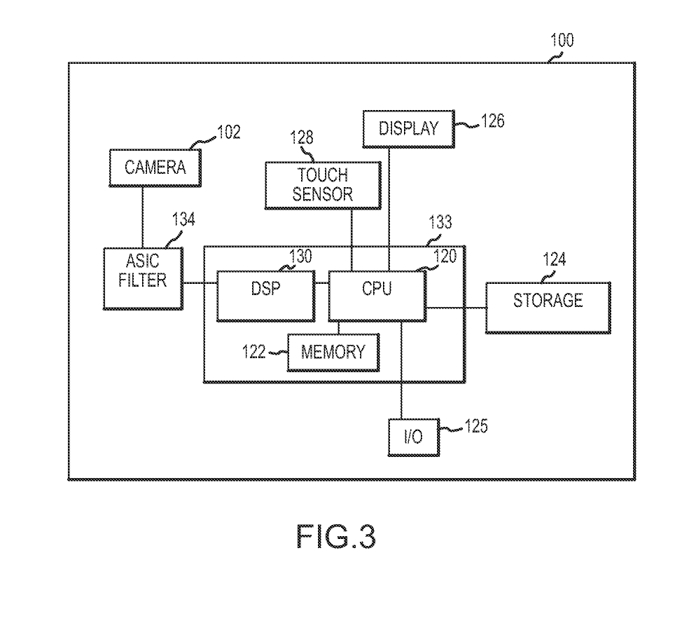

The computing device 100 may include a variety of hardware and software to provide functionality to a user. FIG. 3 is a block diagram of the computing device 100 illustrating some example components that may be included in the computing device. In particular, the computing device 100 includes a central processing unit (CPU) 120, memory 122, storage 124, I/O 125, and a display 126. In some embodiments, touch sensors 128 and/or other sensors may be implemented in conjunction with the display 126 to allow for the display to receive user input, such as though touching the display. The I/O 125 may include various ports for coupling with I/O devices, antennas, a gyroscope, an accelerometer, and/or other I/O devices.

Additionally, the computing device 100 may include a digital signal processor (DSP) 130. Generally, the DSP 130 may be a processing device and/or software dedicated to processing digital signals, such as those received from a camera 102. The camera 102 may take any suitable form, such as a complementary metal-oxide semiconductor (CMOS) sensor or a charge coupled device (CCD) sensor, that captures digital images. In some embodiments, the CPU 120, memory 122 and the DSP 130 may be provided together on a system-on-chip (SoC) 133.

An application specific integrated circuit (ASIC) filter 134 is provided to filter noise from images prior to the image data being provided to either the DSP 130 or the CPU 120. The ASIC filter 134 is logically adjacent to the camera 132 and may take the form of a non-linear filter which does not require multiple frames to function and has no feedback. Generally, the filter 134 may examine a set of pixels to determine if a particular pixel is an outlier (e.g., it falls outside a range defined by a maximum and a minimum of the other pixels). If the particular pixel is an outlier, it may be replaced with an average of the other pixels. Thus, outliers are determined based on surrounding pixels and are filtered out as noise. If, however, the particular pixel is not an outlier, the particular pixel is maintained.

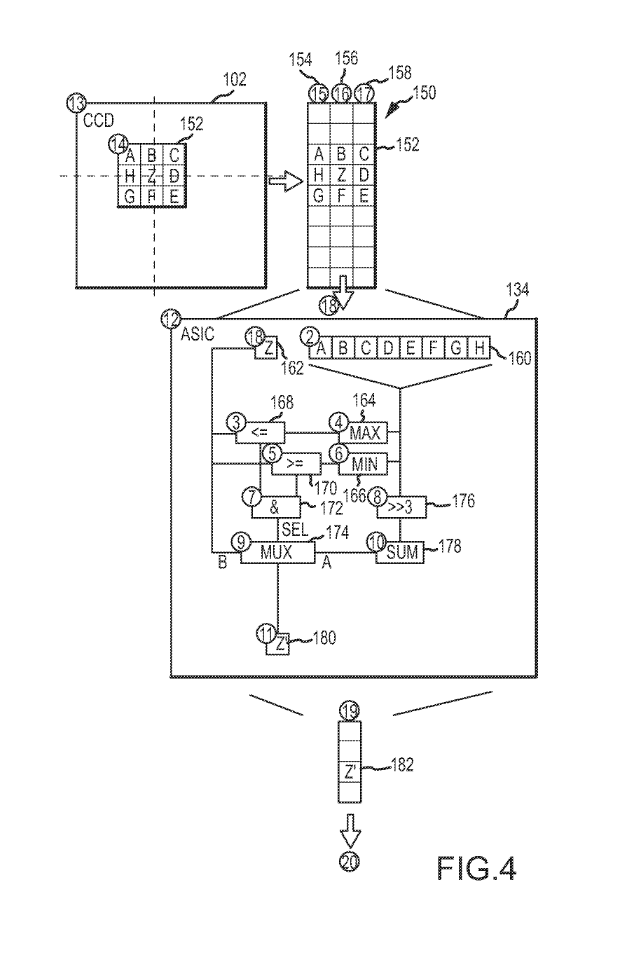

FIG. 4 is a flow diagram generally illustrating a process by which pixels of an image are captured by the camera 102 and passed to and filtered by the ASIC filter 134. For the purposes of this example, a CCD camera may be implemented as the camera 102 and nine pixels of a single frame of an image are considered. Initially, the camera 102 captures an image represented by an array of pixels. The array of pixels captured by the camera 102 may be shifted out of the camera in rows into a first-in-first-out (FIFO) pipeline 150. Generally, the pipeline 150 may include three FIFOs in parallel, so that three rows may be considered simultaneously. Each FIFO may correspond in size to a row of data from the camera 102. For example, each FIFO may be approximately 1K bits. In some embodiments, the FIFO may be 1024 bits, for example, or other size that corresponds to a row of data from the camera 102. The consideration of three rows at a time allows for consideration of a center pixel relative to surrounding pixels. Thus, in some embodiments, nine pixels may be considered as a pixel grouping for the purposes of determining if a center pixel represents noise in the captured image. However, in other embodiments, more or fewer pixels may be considered.

It should be appreciated that the manner in which image data is shifted out of the CCD may vary. For example, some devices may transfer red, blue and green components of an image sequentially and some devices may transfer the red, blue and green components of each pixel interleaved. Depending on the encoding and transfer method, the pixel values may be transformed in a suitable manner before being compared and averaged. Likewise, the definition of average color may vary depending on the encoding and transfer scheme. Regardless, the techniques described herein, once appropriate transform has been performed, will detect and modify pixels having values that are determined to be outliers relative to adjacent pixels.

A pixel grouping 152 is illustrated in the camera 102 and shifted into the FIFO pipeline 150, as part of three rows that are shifted into the pipeline. As may be appreciated, pixel analysis may generally not occur until the pipeline 150 is full (e.g., three clock cycles) and, once full, each clock cycle introduces a new row into the pipeline and pushes out an already considered row. That is, during a first cycle a first row may fill the first FIFO register 154. In a second clock cycle, a second row may fill the first FIFO register 154 and the first row is shifted to the second FIFO register 156. In a third clock cycle, a third row may fill the first FIFO register 154, the second row may fill the second FIFO register 156 and the first row may fill the third FIFO register 158. Each subsequent clock cycle will introduce a new row of pixels and dismiss an already considered row of pixels.

Once the group of pixels 152 is in the pipeline, eight of the pixels may be read into a vector register 160 of the ASIC filter 134. The remaining pixel (or target pixel) may be read into another register 162. In this example, the eight pixels (a, b, c, d, e, f, g, and h) include the pixels surrounding a center pixel and the center pixel (z) is the target pixel. In other embodiments, a pixel from another location within the pixel grouping 152 may be selected as the target pixel. Each pixel in the pixel grouping 152 may have a value associated therewith that represents the characteristics of the pixel. For example, the pixel value may represent the color, hue, brightness, and so forth of the pixel.

A maximum value may be determined by a max comparator 164 for the eight pixels of the pixel grouping 152 that are read into the vector register 160. A minimum value may also be found for the eight pixels by a minimum comparator 166. The target pixel is compared with the maximum and minimum values to find if the target pixel is less than or equal to the maximum value and greater than or equal to the minimum value. Comparators 168 and 170 may be implemented and may provide true or false outputs based on the comparisons. In other embodiments, it may be determined if the target value is greater than the maximum value and/or if the target value is less than or equal to the minimum value. The results of the comparisons provide a true or false output, which may be represented as a logical “1” or “0,” for example. The true or false outputs may be combined using a logic gate 172, such as a logical AND gate, to produce a “select” input to a multiplexer 174.

Simultaneous to the determination of maximums and minimums, determining if the target pixel is an outlier, and providing the select signal to the multiplexer 174, an average of the eight pixels is determined. In particular, in some embodiments, each of the eight pixels may be divided by eight by divider 176 (e.g., by shifting each three spaces to the right within a register) and then summed by the vector summing machine 178 with the other divided values to produce an average. The average of the eight pixels is provided as an input to the multiplexer 174. The target pixel is also provided as an input to the multiplexer 174. The select input determines whether the average of the eight pixels is output or the target pixel. The output value z′ 180 is used in place of the target pixel z and output 182 from the ASIC filter 134. If the output value z′ is the average value of the eight pixels, the target pixel was determined to be noise.

It should be appreciated, that the ASIC filter 134 may be manufactured to provide the specific logic required to perform the desired functions described herein. In some embodiments, a field programmable gate array (FPGA) may be programmed to provide the functionality of the ASIC filter 134 and, as such, may be used in place of an ASIC. Moreover, in some embodiments, discrete components may be implemented to provide some or all of the functionality of the ASIC filter 134. As such, it should be appreciated that the specific embodiments described herein are provided as examples.

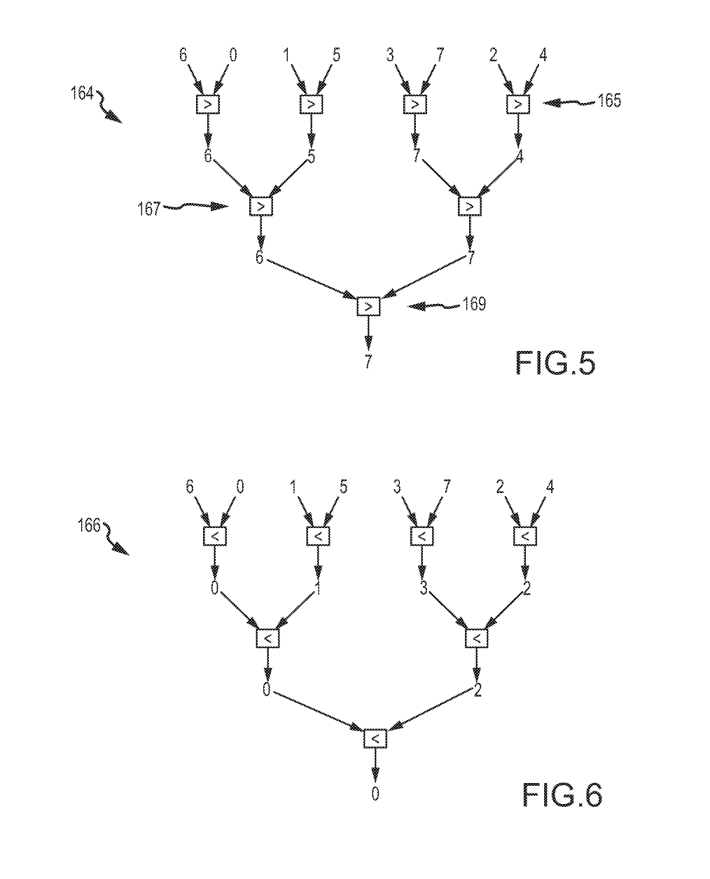

FIGS. 5-13 illustrate each of the various processes of the ASIC filter 134 using an example vector having pixel values 6, 0, 1, 5, 3, 7, 2, and 4, and a target pixel having a value of 6. It should be appreciated that the values may take any suitable form such as decimal, whole, binary, hexadecimal, or other suitable form. FIG. 5 shows the maximum comparator 164 having three tiers of comparators. In the first tier 165, each of the values are compared with another value. The higher values passes through to the next tier 167 for further comparison. After the third tier 169, the maximum value (7) is output. FIG. 6 illustrates the minimum comparator 166 and also includes three tiers but with the output of the final tier being the minimum value (0) of the vector.

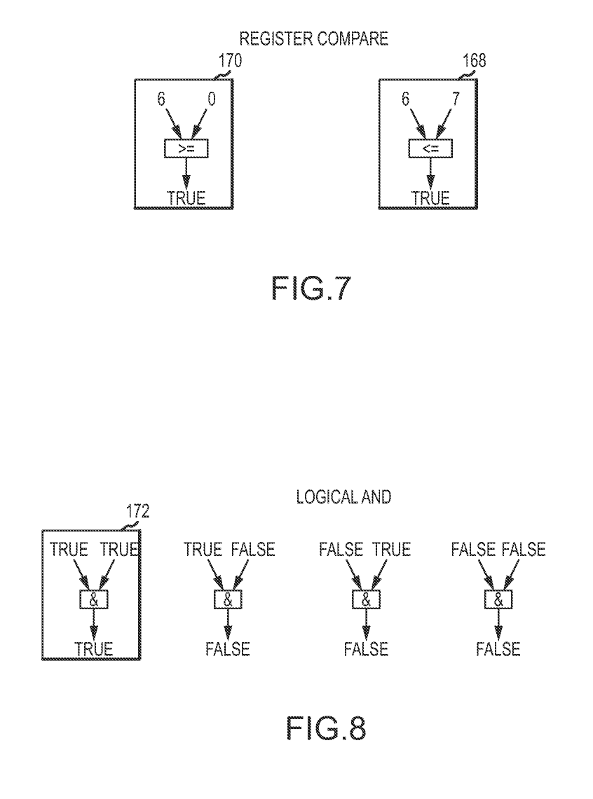

FIG. 7 illustrates the comparators 170 and 168. The comparator 168 determines if the target value (6) is less than or equal to the maximum value (7). The comparator 170 determines if the target value (6) is greater than or equal to the minimum value (0). Following the example, four is greater than zero and less than seven, so each comparator 168 and 170 outputs a “true” signal. It should be appreciated that the true signal may take the form of a binary “1” or other suitable form. The “true” signals from the comparators 168 and 170 are provided to the AND gate 172, shown in FIG. 8. Following conventional gate logic, the AND gate 172 outputs a “true” signal because two true signals were provided as input. If either signal from the comparators 168 and 170 were false, a false signal would have been output by the AND gate 172, as further shown in FIG. 8.

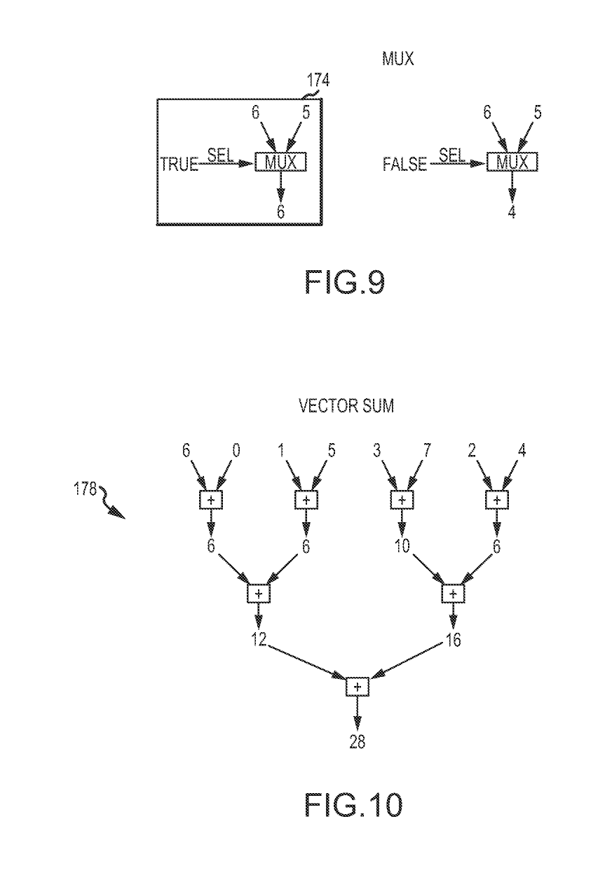

The output of the AND gate 172 is provided to the multiplexer 174 illustrated in FIG. 9 to the “sel” input to determine the output of the multiplexer. If the sel input is “true,” then the output of the multiplexer 174 may be the target value (6). If, however, the sel input if “false,” then the average value (4) of the pixel values is output to replace the target value.

FIG. 10 illustrates the vector summing machine 178 as a tiered summing machine. Generally, the summing of the vector is performed in a log base two of N stages. So, if the sum of the eight values in the vector is desired, three stages are implemented. Each stage is a delay stage and not a computational stage. As such, the summing occurs very rapidly. For example, the summing of eight values may be performed in three nanoseconds or less. Referring again to the example vector values, the sum is 28.

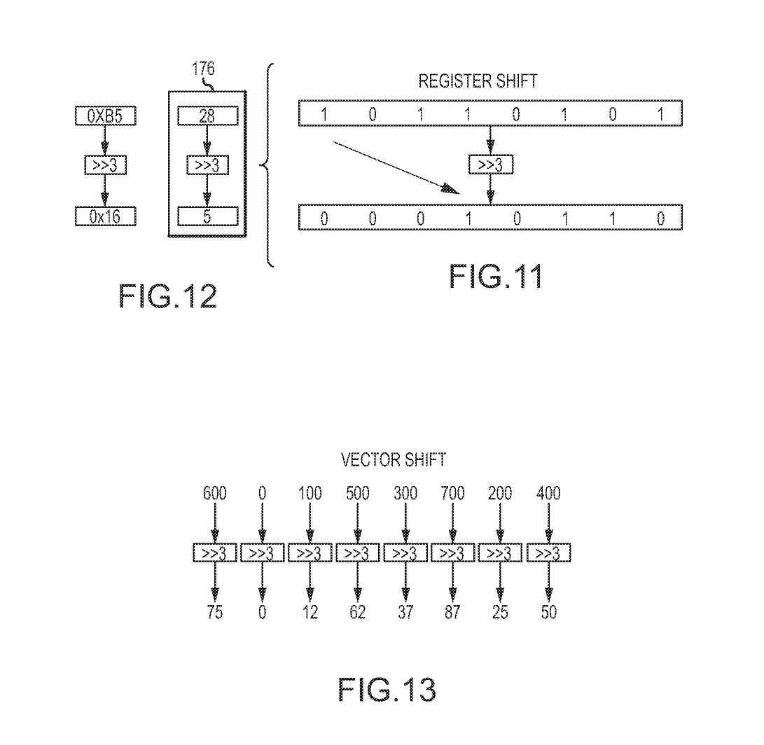

The sum may be divided by eight by the divider 178. Generally, the divider may take the form of a register shift. Specifically, to divide by eight a three bit shift to the right of the bits in the register may be implemented, as illustrated in FIG. 11. This may be a zero time operation because it may be performed by simply wiring the register to output shifted register values and inserting zeros to fill the left hand side of the register. Other examples of register shifts to achieve a divide by eight are illustrated in FIG. 12. Specifically, a hexadecimal divide by eight is performed on 0xB5 to output 0x16. Also, a register shift is performed by the divider 176 to divide 0x28 by eight and output 5 (assuming for FIG. 12 that the 28 output by the summing machine 178 is a hexadecimal number). As may be appreciated, in some embodiments, the divide by eight may result in non-whole numbers. In these instances, the number may be rounded up, rounded down or otherwise modified to accommodate a desired result. For the purposes of this discussion, dividing 28 by eight results in 3.5 which is rounded up to 4. Furthermore, it should be appreciated, that although single digits have been given as examples for the pixel values, in an actual implementation, the values may have multiple digits. Moreover, the register shift may be performed on a vector having multiple different registers simultaneously, as illustrated in FIG. 13. In the example illustrated in FIG. 13, each pixel value has been multiplied by 100.

The result of the divide by eight following the summing of the values results in an average value being output. The average value is provided to the multiplexer 174, as discussed above, and may be used to replace an outlier target value. The processing that occurs within the ASIC filter 134 occurs in real time once the pipeline is full, so filtered data is output clean from the ASIC filter as fast as it is received from the camera 102. Because, all of the processing occurs within the ASIC filter 134 before the image data is passed to the DSP 130 or the CPU 120, there is no memory access, thus reducing the power expended, computational expense and time it takes to process video images.

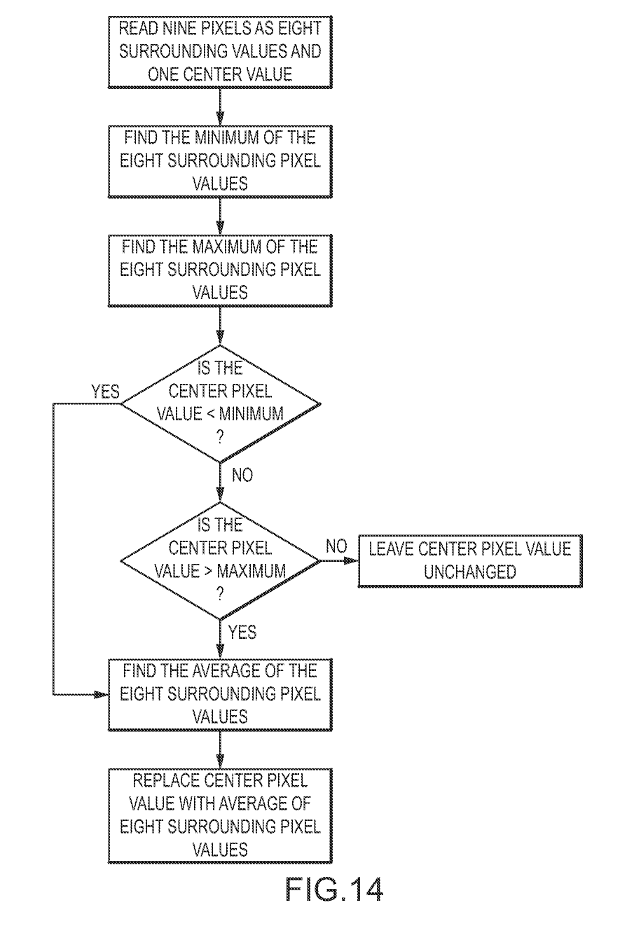

FIG. 14 illustrates a method 200 for filtering noise from a captured image using the ASIC filter 234. Initially, nine values representing pixels are read into the ASIC filter 234 (Block 202). As discussed above, eight of the pixel values are read into a vector register and the ninth pixel value may be read into a separate register. A minimum of the eight values read into the vector register is determined (Block 204) as is the maximum for the eight values (Block 206). The ninth pixel value, which in some embodiments may be a value representing the center block, is then compared with the minimum value to determine if it is less than the minimum value (Block 208). Additionally, it is determined if the ninth value is greater than the maximum of the eight values (Block 210). If the ninth value is greater than the minimum and less than the maximum, the ninth value is retained and used for the center pixel (Block 212). However, if the ninth value is less than the minimum or greater than the maximum, an average of the eight values is found (Block 214) and the ninth value is replaced by the average value (Block 216). It should be appreciated that one or more steps of the method 200 may be performed simultaneously. For example, the minimum and maximum values may be determined simultaneously, and their respective comparisons with the ninth value may occur at the same time as well.

In some embodiments, an application specific integrated circuit may be coupled to an image capture device and configured to filter image data prior to providing the filtered image data to a processor for further processing and/or before writing the data to memory or storage, thus reducing the computational expense of filtering the data and reducing the power consumption of the filtering process.

In some embodiments, the hardware algorithm disclosed herein may convert multiple planes to luminance data in real time hardware. That is, a color image may be converted to a luminance only image (e.g., a black and white image) using hardware and then the noise may be removed from the luminance channel by hardware. For example, if a pixel value is encoded as a single number, the pixel values received from the CCD may be encoded as 24 bit numbers consisting of eight red bits, eight green bits and eight blue bits. A black and white image consisting of luminance (brightness) data may be derived using hardware shifts and adds. Specifically, a value representing luminance of an RGB pixel may be achieve using the formula:

Luminance value=(11*red+16*green+5*blue)/32).

As such, the luminance value may be determined and the noise filter may be applied to the luminance data. In the case of nine total pixels (eight pixels plus one), the pixel values would be converted to luminance values and the output would be the noise filtered luminance channel.

The foregoing discussion describes some example embodiments of a noise filter having reduced power consumption for processing video images. Although the foregoing discussion has presented specific embodiments, persons skilled in the art will recognize that changes may be made in form and detail without departing from the spirit and scope of the embodiments. For example, in some embodiments, the ASIC filter 134 may filter data from memory, replacing the data stored in memory with filtered data. Hence, the filtering may include a single read from and write to memory. Moreover, in some embodiments, the number of pixels considered by the filter may be increased to help provide more robust smoothing of an image. Such embodiments may include additional image capture device storage, wider vector registers, and so forth. Accordingly, the specific embodiments described herein should be understood as examples and not limiting the scope thereof.

1. A computing system comprising:
an image capture device;
a hardware filter coupled to the image capture device, wherein the hardware filter comprises:
an averaging circuit configured to provide an output representing an average value of a first set of values of a pixel grouping; and
an outlier determining circuit configured to determine if a value of a target pixel is outside a range of values for first set of values of the pixel grouping; and
a multiplexer configured to replace the value of the target pixel with the average value if the value of the target pixel is determined to be an outlier.

2. The computing system of claim 1, wherein the averaging circuit comprises a summing circuit coupled serially coupled with a dividing circuit, wherein the dividing circuit comprises a register shifter.

3. The computing system of claim 1, wherein the outlier circuit comprises:
a maximum value determining circuit configured to determine a maximum value of the first set of values;
a minimum value determining circuit configured to determine a minimum value of the first set of values;
a first comparator configured to determine if the value of the target pixel is less than or equal to the maximum value;
a second comparator configured to determine if the value of the target pixel is greater than or equal to the minimum value; and
an AND logic gate configured to receive an output from each of the first and second comparators to determine if the value of the target pixel is an outlier.

4. The computing system of claim 1 further comprising a three row first-in first-out pipeline coupled between the image capture device and the hardware filter.

5. The computing system of claim 1 further comprising:
at least one processor; and
a memory coupled to the at least one processor configured to store captured images.

6. A method of filtering noise from digital images comprising:
reading a set of pixel values into a register pipeline;
finding a minimum value of a first portion of the set of pixel values;
finding a maximum value of the first portion of the set of pixel values;
determining an average value of the first set of pixels;
comparing a value of a target pixel with the minimum and maximum values to determine if the value of the target pixel is an outlier;
replacing the value of the target pixel with the average value if the value of the target pixel is an outlier; and
restoring the value of the target pixel within an array of pixels if the value of the target pixel is not an outlier.

7. A power reduction system comprising:
a processor;
a charge-coupled device (CCD) for image capture coupled to the processor;
a filter device coupled to between the CCD and the processor comprising configured to determine if a value of a target pixel is an outlier relative to a range of values representing a set of pixels surrounding the target pixel, wherein if the target pixel is an outlier, the filter device replaces the value of the target pixel with an average values of the pixels surrounding the target pixels and outputs the average values, and wherein if the value of the target pixel is within the range of values representing the pixels surrounding the target pixel, the set of hardware outputs the value of the target pixel.

8. The power reduction system of claim 7, wherein the device comprises an application specific integrated circuit (ASIC).

9. The power reduction system of claim 7, wherein the device comprises a field programmable gate array.

10. The power reduction system of claim 7, further comprising a register coupled to the CCD configured to receive rows of pixel values from the CCD.

11. The power reduction system of claim 10, wherein the register comprises a three row, first-in-first-out (FIFO) register.

12. The power reduction system of claim 11, wherein the filter device reads a first set of values of a pixel grouping into a vector and a second set of values of the pixel grouping into a register.

13. The power reduction system of claim 12, wherein the first set of values of the pixel grouping comprises eight pixel values and the second set of values comprises a target value.

14. The power reduction system of claim 7, wherein the filter device comprises:
a vector storing a first set of values of a pixel grouping;
a summing machine coupled to the vector and configured to sum values from a first set of pixel values of a pixel grouping; and
a divider coupled to the summing machine configured to divide the sum of the first set of pixel values to provide an average value for the first set of value ranges.

15. The power reduction system of claim 14, wherein the summing machine comprises a log base two summing machine.

16. The power reduction system of claim 14, wherein the divider comprises a register shift.

17. The power reduction system of claim 16, wherein the register shift is a wired register shift that shifts register values three bits to the right.

18. The power reduction system of claim 14, further comprising:
a first comparator coupled to the vector and configured to determine a maximum value for the first set of values; and
a second comparator coupled to the vector and configured to determine a minimum value for the first set of values.

19. The power reduction system of claim 18, further comprising:
a register storing a value for a target pixel;
a third comparator coupled to the register and the first comparator and configured to determine if the value for the target pixel is greater than a maximum value of the first set of values and output a true signal if it is not and a false signal if so;
a fourth comparator coupled to the register and the second comparator and configured to determine if the value for the target pixel is less than a minimum value of the first set of values and output a true signal if it is not and a false signal if so.

20. The power reduction system of claim 19 further comprising:
an AND logic block receiving the output signals of the third and fourth comparators and outputting a true signal if the output signals of the third and fourth comparators are true and a false signal if not; and
a multiplexer coupled to the AND logic block receiving the output signal therefrom and also receiving the value for the target pixel and an average value for the first set of pixel values, the multiplexer configured to output the value of the target pixel if the target pixel is not an outlier and to output the average value if the value of the target pixel is an outlier.
